(19) United States
(12) Patent Application Publication
(10) Pub. No.: US 2015/0295421 A1
(43) Pub. Date: Oct. 15, 2015

(54) ACTIVE ISOLATED CIRCUIT FOR PRECHARGING AND DISCHARGING A HIGH VOLTAGE BUS

(71) Applicant: Ford Global Technologies, LLC, Dearborn, MI (US)

(72) Inventors: Bruce Carvell Blakemore, Plymouth, MI (US); Allan Roy Gale, Livonia, MI (US); Michael W. Degner, Novi, MI (US); Arnold Kweku Mensah-Brown, Canton, MI (US); Chih-Lun Wang, Westland, MI (US)

(73) Assignee: Ford Global Technologies, LLC, Dearborn, MI (US)

(21) Appl. No.: 14/250,231

(22) Filed: Apr. 10, 2014

(51) Int. Cl. H02J 7/00; H02M 3/335; G06F 13/40

(52) U.S. Cl. CPC H02J 7/007; G06F 13/4077; H02J 7/0068; H02M 3/33507

(57) ABSTRACT

An active isolated circuit is provided for precharging and discharging a high voltage bus, such as within a hybrid electric vehicle, in a quick, efficient, and optimal manner. The circuit can include a battery, a DC-DC converter coupled between the battery and a main contactor, the main contactor coupled between the converter and a bus for selectively connecting the battery to the bus through the converter, and a control module for controlling the converter to selectively precharge the bus from the battery and selectively discharge the bus to the battery. The converter can be configured to isolate the battery and the bus. When a precharge signal is generated, the bus can be precharged from the battery through a transformer in the converter. The bus can be discharged to the battery through the transformer in the converter when a discharge signal is generated.

### TECHNICAL FIELD

This application generally relates to precharging and discharging a high voltage bus, and in particular, to using an active isolated circuit to precharge a high voltage bus from a high voltage battery and discharge the high voltage bus to the high voltage battery, such as in a hybrid electric vehicle.

### BACKGROUND

Hybrid electric vehicles use an internal combustion engine and electric motors for propulsion. The electric motors can be powered by a battery that is usually at a high voltage, such as 200-300 volts. The battery and the electric motors can be electrically connected to each other by a high voltage bus that carries current from the battery to the electric motor and/or to other components of the vehicle. The high voltage bus and the battery can be connected through a main contactor during normal operation of the vehicle.

Prior to normal operation of the vehicle, the high voltage bus may be at a voltage less than the voltage of the battery. When normal operation of the vehicle is desired, the high voltage bus is typically precharged by connecting the high voltage bus to the battery through a precharge contactor and a resistor, so that the voltage of the high voltage bus is brought up to the voltage of the battery within a certain tolerance, such as 10 V. After the high voltage bus is precharged, a main contactor can be closed to directly connect the battery to the high voltage bus. However, while this type of precharging brings the voltage of the high voltage bus close to the voltage of the battery, the high voltage bus may not be precharged in the quickest, most efficient, and optimal way.

Accordingly, there is an opportunity for systems and methods for precharging and discharging a high voltage bus using an active isolated circuit to allow the high voltage bus to be precharged and discharged in a quick, efficient, and optimal way.

### SUMMARY

In one embodiment, a circuit is provided for precharging and discharging a bus. The circuit includes a battery, a DC-DC converter coupled between the battery and a main contactor, the main contactor coupled between the converter and a bus for selectively connecting the battery to the bus through the converter, and a control module for controlling the converter to selectively precharge the bus from the battery and selectively discharge the bus to the battery. The converter can be configured to isolate the battery and the bus.

In another embodiment, a method is provided for precharging a bus from a battery. The method includes controlling a DC-DC converter to precharge the bus from the battery through the converter. When the voltage of the bus is approximately a voltage of the battery, the converter can be controlled to stop precharging the bus from the battery and a main contactor can be closed to connect the battery directly to the bus.

In a further embodiment, a method is provided for discharging a bus to a battery. The method includes opening a main contactor to disconnect the battery from the bus, and controlling a DC-DC converter to discharge the bus to the battery through the converter. When the voltage of the bus is approximately a predetermined voltage that is less than a voltage of the battery, then the converter can be controlled to stop discharging the bus to the battery.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic of an embodiment of an active isolated circuit for precharging and discharging a high voltage bus.

FIG. 2 is a schematic of an embodiment of a DC-DC converter of an active isolated circuit for precharging and discharging a high voltage bus.

FIG. 3 is a flowchart illustrating operations for precharging a high voltage bus using an active isolated circuit.

FIG. 4 is a flowchart illustrating operations for discharging a high voltage bus using an active isolated circuit.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

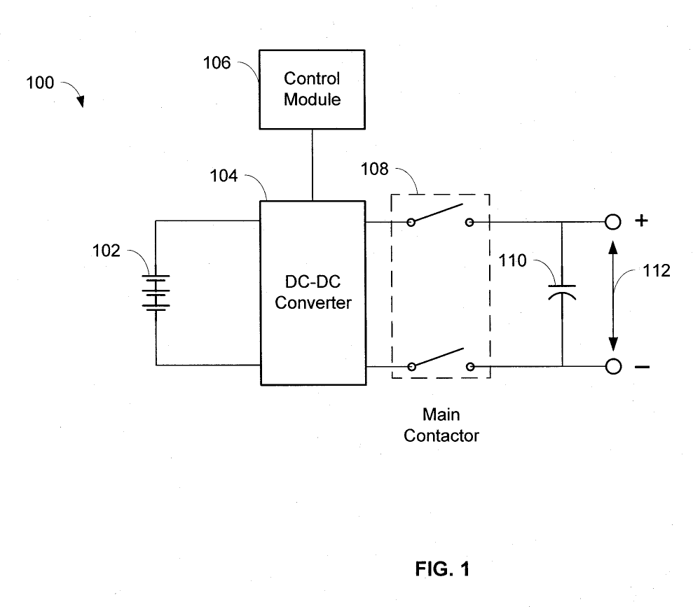

FIG. 1 illustrates a schematic of an embodiment of an active isolated circuit 100 for precharging and discharging a high voltage bus 112. The high voltage bus 112 may be selectively connected to a high voltage battery 102 in a hybrid electric vehicle, for example, so that the high voltage bus 112 can power one or more electric motors (not shown) for propulsion of the vehicle. The high voltage bus 112 can also power other components of the vehicle that utilize the high voltage. The battery 102 may be 200 V, 300 V, or another appropriate voltage. A capacitor 110 of the high voltage bus 112 is shown in FIG. 1 that represents the lumped capacitance of the various loads on the high voltage bus 112, e.g., the electric motors and other components. The capacitor 110 may have a capacitance of 1000 μF, for example, or another appropriate capacitance.

The circuit 100 can quickly, efficiently, and optimally precharge the high voltage bus 112 from the battery 102, and discharge the high voltage bus 112 to the battery 102 through a DC-DC converter 104. A control module 106 can generate and transmit control signals and/or pulse-width modulation signals to the DC-DC converter 104 to control whether the high voltage bus 112 is being precharged or discharged. The control signals may include, for example, a precharge signal and/or a discharge signal. The pulse-width modulation signals may be used during precharging of the high voltage bus 112. The control module 106 may be, for example, a high voltage battery control module that can also control other battery-related functionality, such as thermal management, leakage detection, and other battery control functions. In some embodiments, the control module 106 may be electrically supplied by another bus that is at a different voltage, e.g., a low voltage bus at 12 V, than the high voltage bus 112.

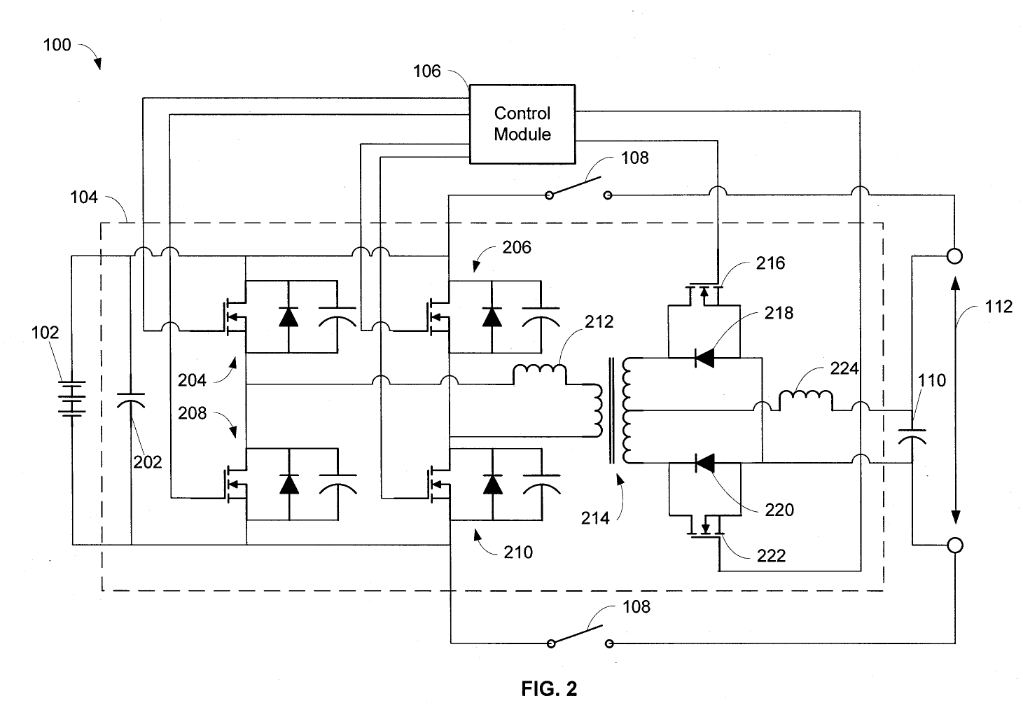

To allow precharging and discharging of the high voltage bus 112, the DC-DC converter 104 may be configured to be bidirectional. In particular, the high voltage bus 112 can be precharged from the battery 102 through the DC-DC converter 104 to nearly the voltage of the battery 102 within a certain timeframe when normal operation of the vehicle is desired, such as when the vehicle is turned on. For example, the high voltage bus 112 may be required to be precharged to 300 V within 100 ms. The high voltage bus 112 can also be discharged to the battery 102 through the DC-DC converter 104 to a predetermined voltage (that is less than the voltage of the battery 102) within a certain timeframe when normal operation of the vehicle is terminated, such as when the vehicle is shut down. For example, the high voltage bus 112 may be required to be discharged to 42 V within 1-3 seconds. The circuit 100 and the DC-DC converter 104 may be used in lieu of a dedicated precharge circuit (e.g., precharge resistor and precharge contactor) and a dedicated discharge circuit that may be used to precharge and discharge existing high voltage buses, respectively. The DC-DC converter 104 may isolate the battery 102 and the high voltage bus 112. An embodiment of the DC-DC converter 104 is described in more detail below in reference to FIG. 2.

A main contactor 108 may be closed to directly connect the battery 102 and the high voltage bus 112 when the vehicle is in normal operation. The main contactor 108 may be open so that the battery 102 is not directly connected to the high voltage bus 112 when the vehicle is turned off and not in normal operation, e.g., shut down after the high voltage bus 112 has been discharged; when the vehicle is being started and the high voltage bus 112 is being precharged from the battery 102; and when the vehicle is in the process of being shut down and the high voltage bus 112 is being discharged to the battery 102. The main contactor 108 may be a relay, for example. In some embodiments, the main contactor 108 may be electrically supplied by another bus that is at a different voltage, e.g., a low voltage bus at 12 V, than the high voltage bus 112. The control module 106 and/or another module may transmit commands to the main contactor 108 to open and close.

FIG. 2 illustrates a schematic of an embodiment of the DC-DC converter 104 in the active isolated circuit 100 for precharging and discharging a high voltage bus 112. The DC-DC converter 104 may include a transformer 214 that isolates the battery 102 and the high voltage bus 112 and converts between the voltages of the battery 102 and the high voltage bus 112. The turns ratio between the primary winding and secondary winding of the transformer 214 may determine the voltage conversion of the DC-DC converter 104. In one embodiment, the turns ratio of the transformer 214 may be unity. In this case, the voltage of the battery 102 is unchanged across the transformer 214 when precharging the high voltage bus 112 from the battery 102.

The primary side of the DC-DC converter 104 may include a switching circuit (made up of subcircuits 204, 206, 208, and 210), a capacitor 202 that represents a lumped capacitance on the primary side of the DC-DC converter 104, and an inductor 212 coupled to the subcircuits 204 and 208 and the primary winding of the transformer 214. The switching circuit may selectively connect the battery 102 and the high voltage bus 112 through the transformer 214 for precharging or discharging the high voltage bus 112. The subcircuits 204, 206, 208, and 210 of the switching circuit may each include an n-channel MOSFET, a diode, and a capacitor that are connected in parallel. Although n-channel MOSFETs are shown in the subcircuits 204, 206, 208, and 210, other types of transistors or switches may be utilized in the subcircuits 204, 206, 208, and 210, such as p-channel MOSFETs and/or insulated-gate bipolar transistors (IGBTs). As shown in FIG. 2, the subcircuits 204, 206, 208, and 210 may be arranged in an H bridge configuration that enables the precharging of the high voltage bus 112 from the battery 102 through the transformer 214, and the discharging of the high voltage bus 112 to the battery 102 through the transformer 214, depending on which of the MOSFETs are active. The gates of each of the MOSFETs in the subcircuits 204, 206, 208, and 210 may be coupled to control signals from the control module 106 that determine which of the MOSFETs are active when either precharging or discharging the high voltage bus 112, as described further below.

The secondary side of the DC-DC converter 104 may include a circuit (made up of the MOSFETs 216 and 222 and the diodes 218 and 220) coupled between the secondary winding of the transformer 214 and the high voltage bus 112. An inductor 224 is also coupled to a center tap of the transformer 214, the capacitor 110, and the high voltage bus 112. As described above, the capacitor 110 represents a lumped capacitance of the high voltage bus 112. The circuit on the secondary side of the DC-DC converter 104 may selectively connect the battery 102 and the high voltage bus 112 through the transformer 214 for precharging the high voltage bus 112, using the MOSFETs 216 and 222. The circuit may also connect the battery 102 and the high voltage bus 112 through the transformer 214 for discharging the high voltage bus 112, using the diodes 218 and 220, when the MOSFETs in the subcircuits 204, 206, 208, and 210 are appropriately activated. As shown in FIG. 2, each of the MOSFETs 216 and 222 are coupled in parallel with the diodes 218 and 220, and are also connected to the secondary winding of the transformer 214. Although the MOSFETs 216 and 222 are shown as n-channel MOSFETs, other types of transistors or switches may be utilized, such as p-channel MOSFETs and/or IGBTs.

The gates of the MOSFETs 216 and 222 may be coupled to a pulse-width modulation (PWM) signal generator in the control module 106. The PWM signals may be generated and transmitted to the gates of the MOSFETs 216 and 222 when the high voltage bus 112 is being precharged. The duty cycle of the PWM signals may increase linearly as the voltage of the high voltage bus 112 increases during precharging. For example, if the voltage of the high voltage bus 112 is 0 V at a first time instance, then the duty cycle of the PWM signals may be relatively low (e.g., near 0%) so that the pulse widths are narrow. As the voltage of the high voltage bus 112 increases during precharging, the duty cycle of the PWM signals may approach 50% so that the pulse widths are wider.

In operation, the circuit 100 and the DC-DC converter 104 can precharge the high voltage bus 112 when the voltage of the high voltage bus 112 is less than the voltage of the battery 102. For example, the voltage of the high voltage bus 112 may be at 0 V at an initial time instance t=0, such as when the vehicle is turned off and not in normal operation. Precharging the high voltage bus 112 is intended to raise the voltage of the high voltage bus 112 to nearly the voltage of the battery 102 so that the main contactor 108 can later be closed for commencing normal operation of the vehicle.

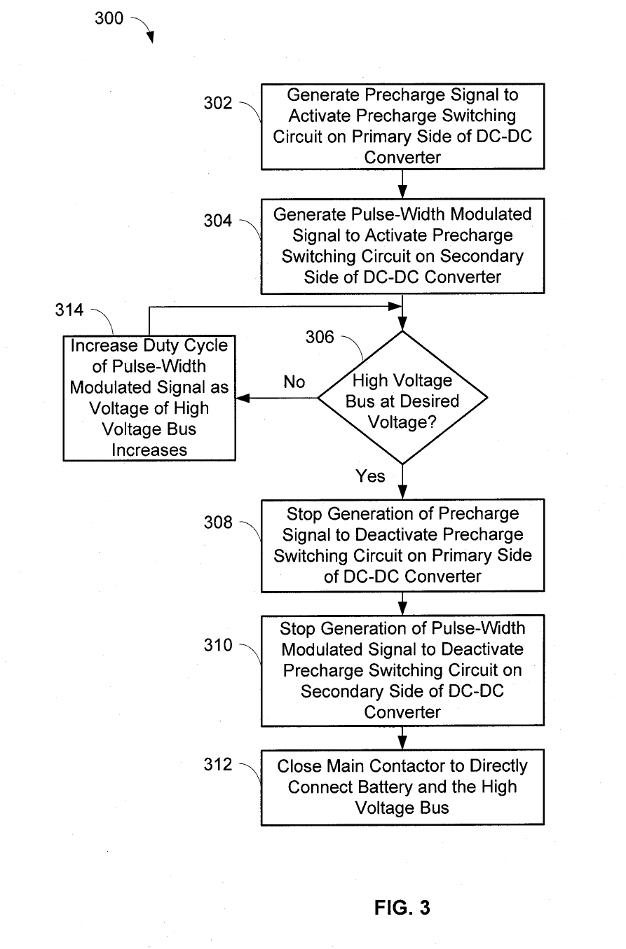

The time to precharge the high voltage bus 112 may vary depending on the particular specifications and requirements for the systems in a vehicle. For example, it may be specified that the high voltage bus 112 should be precharged to 300 V within 100 ms. When the vehicle is turned on to begin normal operation, the high voltage bus 112 may be precharged. A process 300 to precharge the high voltage bus 112 is shown in FIG. 3. The control module 106 may generate and transmit a precharge signal to the gates of the MOSFETs in the subcircuits 204 and 210 on the primary side of the DC-DC converter 104, such as at step 302 of the process 300. A PWM generator in the control module 106 may also generate and transmit PWM signals to the gates of the MOSFETs 216 and 222 on the secondary side of the DC-DC converter 104, such as at step 304 of the process 300.

The precharge signal may activate the MOSFETs in the subcircuits 204 and 210 so that energy can be drawn from the battery 102 through the subcircuits 204 and 210 to the primary winding of the transformer 214. The MOSFETs 216 and 222 may be activated based on the duty cycle of the PWM signals. The high voltage bus 112 may accordingly be precharged from the battery 102 through the subcircuits 204 and 210, the transformer 214, and the MOSFETs 216 and 222. The voltage of the high voltage bus 112 can be monitored, such as at step 306 of the process 300, to determine whether the voltage of the high voltage bus 112 is at a desired voltage, e.g., nearly the voltage of the battery 102. If the voltage of the high voltage bus 112 is not yet at the desired voltage at step 306, then the process 300 can continue to step 314. The duty cycle of the PWM signals to the MOSFETs 216 and 222 can be increased at step 314 as the voltage of the high voltage bus 112 increases, as described above. The process 300 can subsequently continue back to step 306 to monitor the voltage of the high voltage bus 112.

When the voltage of the high voltage bus 112 is at the desired voltage at step 306, then the process 300 can continue to step 308. Generation of the precharge signal can be stopped by the control module 106 at step 308 so that the MOSFETs in the subcircuits 204 and 210 are deactivated. Generation of the PWM signals can also be stopped at step 310 so that the MOSFETs 216 and 222 are deactivated. The high voltage bus 112 is no longer being precharged when the MOSFETs in the subcircuits 204 and 210 and the MOSFETs 216 and 222 are deactivated. Because the voltage of the high voltage bus 112 is at the desired voltage at this point, the main contactor 108 can be closed, such as at step 312, to directly connect the battery 102 and the high voltage bus 112. The vehicle can be in normal operation when the main contactor 108 is closed so that the battery 102 directly powers the electric motors and other components on the high voltage bus 112.

The circuit 100 and the DC-DC converter 104 can also discharge the high voltage bus 112 when the voltage of the high voltage bus 112 is approximately the voltage of the battery 102. For example, the voltage of the high voltage bus 112 may be at 300 V at a time t=0, such as when the vehicle is in normal operation. Discharging the high voltage bus 112 is intended to lower the voltage of the high voltage bus 112 to a predetermined voltage that is less than the voltage of the battery 102. The high voltage bus 112 may be discharged when the vehicle is being shut down, for example. The main contactor 108 can be opened prior to discharging the high voltage bus 112.

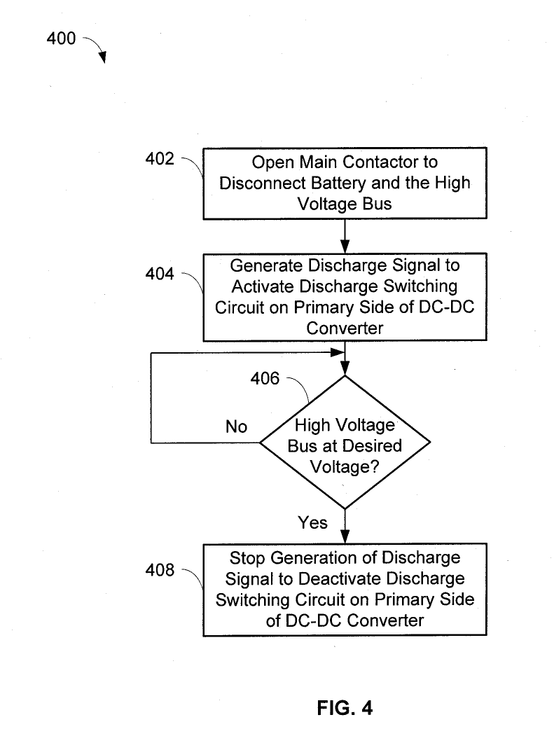

The time to discharge the high voltage bus 112 may vary depending on the particular specifications and requirements for the systems in a vehicle. For example, the high voltage bus 112 may be required to be discharged to 42 V within 1-3 seconds. When the vehicle is turned off to be shut down after normal operation, the high voltage bus 112 may be discharged. A process 400 to discharge the high voltage bus 112 is shown in FIG. 4. The main contactor 108 may be opened, such as at step 402, so that the battery 102 is disconnected from the high voltage bus 112. The control module 106 may generate and transmit a discharge signal to the gates of the MOSFETs in the subcircuits 206 and 208 on the primary side of the DC-DC converter 104, such as at step 404 of the process 400. The discharge signal may activate the MOSFETs in the subcircuits 206 and 208 so that energy can be drawn from the high voltage bus 112 through the transformer 214 and the subcircuits 206 and 208. The energy can be drawn from the high voltage bus 112 through the diodes 218 and 220 and the secondary winding of the transformer 214 on the secondary side of the DC-DC converter 104 to the primary winding of the transformer 214. The high voltage bus 112 may accordingly be discharged to the battery 102 through the diodes 218 and 220, the transformer 214, and the subcircuits 206 and 208.

The voltage of the high voltage bus 112 can be monitored, such as at step 406 of the process 400, to determine whether the voltage of the high voltage bus 112 is at a desired voltage, e.g., a predetermined voltage less than the voltage of the battery 102. If the voltage of the high voltage bus 112 is not yet at the desired voltage at step 406, then the process 400 can remain at step 406 to continue monitoring of the voltage of the high voltage bus 112. However, if the voltage of the high voltage bus 112 is at the desired voltage at step 406, then process 400 can continue to step 408. Generation of the discharge signal can be stopped by the control module 106 at step 408 so that the MOSFETs in the subcircuits 206 and 208 are deactivated. The high voltage bus 112 is no longer being discharged when the MOSFETs in the subcircuits 206 and 208 are deactivated.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A circuit, comprising:
a battery;
a DC-DC converter coupled between the battery and a main contactor;
the main contactor coupled between the converter and a bus for selectively connecting the battery to the bus through the converter; and
a control module for controlling the converter to selectively precharge the bus from the battery and selectively discharge the bus to the battery;
wherein the converter is configured to isolate the battery and the bus.

2. The circuit of claim 1, wherein the DC-DC converter comprises:
a transformer having a primary winding and a secondary winding;
a primary side switching circuit coupled to the battery and the primary winding, wherein the primary side switching circuit is for selectively connecting the battery and the bus through the transformer for precharging the bus, based on a precharge signal from the control module, and for discharging the bus, based on a discharge signal from the control module; and
a secondary side circuit coupled to the secondary winding and the bus, wherein the secondary side circuit is for:
selectively connecting the battery and the bus through the transformer for precharging the bus, based on a pulse-width modulation signal from the control module; and
connecting the battery and the bus through the transformer for discharging the bus.

3. The circuit of claim 2, wherein the primary side switching circuit comprises:
a first pair of transistors for selectively connecting the battery to the primary winding to precharge the bus from the battery through the transformer, based on the precharge signal; and
a second pair of transistors for selectively connecting the battery to the primary winding to discharge the bus to the battery through the transformer, based on the discharge signal.

4. The circuit of claim 3, wherein the primary side switching circuit further comprises:
a first pair of diodes each coupled in parallel with each of the first pair of transistors;
a first pair of capacitors each coupled in parallel with each of the first pair of transistors and each of the first pair of diodes;
a second pair of diodes each coupled in parallel with each of the second pair of transistors; and
a second pair of capacitors each coupled in parallel with each of the second pair of transistors and each of the second pair of diodes.

5. The circuit of claim 2, wherein:
the transformer comprises a center-tap transformer;
a center tap of the secondary winding is coupled to a positive terminal of the bus; and
the secondary side circuit comprises:
a pair of discharge diodes coupled to ends of the secondary winding and a negative terminal of the bus, a cathode of each of the pair of discharge diodes connected to one of the ends of the secondary winding; and
a pair of precharge transistors each coupled in parallel with the pair of discharge diodes and to the negative terminal of the bus, the pair of precharge transistors for selectively connecting the bus to the secondary winding to precharge the bus from the battery through the transformer, based on the pulse-width modulation signal from the control module, wherein the pulse-width modulation signal is active when the precharge signal is active.

6. The circuit of claim 2, wherein a turns ratio of the transformer is approximately unity.

7. The circuit of claim 1, wherein:
a voltage of the bus is less than a voltage of the battery at a first time instance; and
the control module controls the main contactor to open and controls the DC-DC converter to precharge the bus from the battery such that the voltage of the bus increases until the voltage of the bus is approximately the voltage of the battery after a period following the first time instance.

8. The circuit of claim 7, wherein when the voltage of the bus is approximately the voltage of the battery after the period following the first time instance, the control module controls the DC-DC converter to stop precharging the bus from the battery and controls the main contactor to close to directly connect the battery to the bus.

9. The circuit of claim 1, wherein:
a voltage of the bus is approximately a voltage of the battery at a second time instance; and
the control module controls the main contactor to open and controls the DC-DC converter to discharge the bus to the battery such that the voltage of the bus decreases until the voltage of the bus is approximately a predetermined voltage after a period following the second time instance.

10. The circuit of claim 9, wherein when the voltage of the bus is approximately the predetermined voltage after the period following the second time instance, the control module controls the DC-DC converter to stop discharging the bus to the battery.

11. A method, comprising:
controlling a DC-DC converter to precharge a bus from a battery through the converter; and
when the voltage of the bus is approximately a voltage of the battery:
controlling the converter to stop precharging the bus from the battery; and
closing a main contactor to connect the battery directly to the bus.

12. The method of claim 11, wherein controlling the converter to precharge the bus comprises:
generating a precharge signal from a control module to activate a first switching circuit on a primary side of the converter to connect the battery and the bus through a transformer, wherein the first switching circuit is coupled to the battery and a primary winding of the transformer; and
generating a pulse-width modulation signal from the control module to activate a second switching circuit on a secondary side of the converter to connect the battery and the bus through the transformer, wherein the second switching circuit is coupled to a secondary winding of the transformer and the bus.

13. The method of claim 12, wherein controlling the converter to stop precharging the bus comprises:
stopping generation of the precharge signal to deactivate the first switching circuit; and
stopping generation of the pulse-width modulation signal to deactivate the second switching circuit.

14. The method of claim 12, wherein generating the pulse-width modulation signal comprises increasing a duty cycle of the pulse-width modulation signal as the voltage of the bus increases.

15. The method of claim 12, wherein controlling the converter to precharge the bus comprises:
activating a first pair of transistors of the first switching circuit with the precharge signal to connect the battery to the primary winding; and
activating a pair of precharge transistors of the second switching circuit with the pulse-width modulation signal to connect the secondary winding and the bus.

16. A method, comprising:
opening a main contactor to disconnect a battery from a bus;
controlling a DC-DC converter to discharge the bus to the battery through the converter; and
when the voltage of the bus is approximately a predetermined voltage that is less than a voltage of the battery, controlling the converter to stop discharging the bus to the battery.

17. The method of claim 16, wherein controlling the converter to discharge the bus comprises generating a discharge signal from a control module to activate a switching circuit on a primary side of the converter to connect the battery and the bus through a transformer, wherein the switching circuit is coupled to the battery and a primary winding of the transformer.

18. The method of claim 17, wherein controlling the converter to stop discharging the bus comprises stopping generation of the discharge signal to deactivate the switching circuit.

19. The method of claim 17, wherein controlling the converter to discharge the bus comprises activating a pair of transistors of the switching circuit with the discharge signal to connect the battery to the primary winding.
